(19) United States
(12) Patent Application Publication
(10) Pub. No.: US 2015/0039332 A1
(43) Pub. Date: Feb. 5, 2015

(54) SYSTEMS AND METHODS FOR HEALTH DELIVERY SYSTEMS

(71) Applicant: GEORGIA TECH RESEARCH CORPORATION, Atlanta, GA (US)

(72) Inventors: HYUNWOO PARK, ATLANTA, GA (US); TRUSTIN CLEAR, ATLANTA, GA (US); WILLIAM B. ROUSE, ATLANTA, GA (US); RAHUL C. BASOLE, ATLANTA, GA (US); MARK L. BRAUNSTEIN, ATLANTA, GA (US); KENNETH L. BRIGHAM, ATLANTA, GA (US); LYNN CUNNINGHAM, ATLANTA, GA (US)

(21) Appl. No.: 14/449,009

(22) Filed: Jul. 31, 2014

Related U.S. Application Data
(60) Provisional application No. 61/860,618, filed on Jul. 31, 2013.

(51) Int. Cl. G06F 19/00; G06Q 10/06

(52) U.S. Cl. CPC G06F 19/3431; G06Q 10/0637
USPC 705/2

(57) ABSTRACT

The present invention includes techniques for providing multilevel simulations for healthcare delivery systems. Computational methods may be used to transform the healthcare delivery market to a more efficient model. Multilevel simulations may provide the means to explore a wide range of possibilities, enabling the early identification of good ideas and the discarding of bad ones. This enables simulating the behavior of, among other things, health care policies, strategies, plans, and management practices prior to roll out to avoid, for example, higher-order and unintended consequences.

### CROSS-REFERENCE TO RELATED APPLICATIONS

This application claims priority and the benefit under 35 U.S.C. §119(e) of U.S. Provisional Patent Application No. 61/860,618, filed 31 Jul. 2013, of which the entire contents and substance are hereby incorporated by reference as if fully set forth below.

### BACKGROUND

Advancements in medical science and innovations in clinical practice represent opportunities for improvements in the health and well-being of society. As a result, returns on investment in medically related endeavors can be substantial. Unfortunately, large returns on investment may be difficult to impossible with conventional “non-designed” health systems.

Computational modeling of organizations has been used in both research and practice and has achieved credibility in organization science, military organization, and other disciplines. Such technology can be particularly valuable, for example, for exploring alternative organizational concepts that do not yet exist and, hence, cannot be explored empirically. Thus, the transformation of healthcare delivery is a prime candidate for exploration via organizational simulation.

### SUMMARY

Computational systems and methods are needed to transform the healthcare delivery market. Engineering health delivery will likely require that the current “non-designed” system to be substantially transformed in order to provide high-quality, affordable health care. Multilevel simulations, for example, may provide a means to explore a wide range of possibilities, enabling the early identification of both good and bad ideas. Accordingly, the interaction of health care policies, strategies, plans, and management practices can be simulated prior to roll out to avoid, for example, higher-order and unintended consequences. It is to such systems and methods that embodiments of the present invention are primarily directed.

According to an example embodiment, a method is provided. The method may include receiving patient data representing a plurality of patients. The method may further include determining, for the plurality of patients, a risk level associated with each respective patient for one or more health-related issues. In some embodiments, the health-related issues may include one or more of diabetes mellitus and coronary heart disease. The method may yet further include determining, a first total estimated healthcare cost for the plurality of patients based on the associated risk levels. In some embodiments, the total estimate healthcare cost may include coinsurance amount, copay amount, deductible amount, net payment amount, and third-party amount for all procedures and prescriptions to be administered to each patient in the plurality of patients.

The method may also include determining, based on the associated risk levels, a stratification of the plurality of patients, into a plurality of risk groups, each risk group corresponding to a stratum. In some embodiments, the plurality of risk groups may include at least a high-risk group and a low-risk group. In another embodiment, an associated risk level may be determined at least partially based on the age of a patient.

The method may further include receiving, for each of the plurality of risk groups, a corresponding process-based flow of care. The method may yet further include determining, based on a rate of risk reduction associated with application of the process-based flows of care to the corresponding respective risk groups, a second total estimated healthcare cost for the plurality of patients. The method may still yet further include determining, based on the first and second total estimated healthcare costs, a cost reduction associated with the wellness and prevention program.

According to some example embodiments, various systems are provided. Each system may include a computing device, and a memory operatively coupled to the computing device and configured for storing data and instructions that may be executed by the computing device. When executed, the respective system may be caused to perform a method substantially similar to one the methods described hereinabove.

According to additional example embodiments, various computer program products are provided. Each computer program product may include or be embodied in a non-transitory computer readable medium. The respective computer readable medium may store instructions that, when executed by at least one processor in a system, cause the system to perform a method substantially similar to one of the methods described hereinabove.

Other embodiments, features, and aspects of the present invention are described in detail herein and are considered a part of the claimed present invention. Other embodiments, features, and aspects may be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 depicts a block diagram 100 of illustrative computing device architecture, according to an embodiment of the present invention.

FIG. 2 depicts a flow diagram 200 of a healthcare delivery business, according to an embodiment of the present invention.

FIG. 3 depicts a multilevel simulation dashboard 300, according to an embodiment of the present invention.

FIG. 4 depicts a people level 400 of the multilevel simulation dashboard, according to an embodiment of the present invention.

FIG. 5 depicts a process level 500 of the multilevel simulation dashboard, according to an embodiment of the present invention.

FIG. 6 depicts ecosystem 600 and organization levels 650 of the multilevel simulation dashboard, according to an embodiment of the present invention.

FIG. 7 depicts a graph 700 of reduction of diabetes mellitus risks for users due to the system, according to an embodiment of the present invention.

FIG. 8 depicts a graph 800 of reduction of risk of coronary heart disease for users due to the system, according to an embodiment of the present invention.

FIG. 9 depicts a graph 909 of an increase in terminal age for users due to the system, according to an embodiment of the present invention.

FIG. 10 depicts a graph 910 comparing potential savings for users due to the system vs. the health inflation rate, according to an embodiment of the present invention.

FIG. 11 depicts a graph 911 comparing conventional capitation systems vs. payment for risk reduction, according to an embodiment of the present invention.

FIG. 12 depicts a graph 912 depicting disease risk thresholds for diabetes mellitus vs. coronary heart disease, according to an embodiment of the present invention.

FIG. 13 depicts a flow diagram 1300 of a method, according to an embodiment of the present invention.

### DETAILED DESCRIPTION

Embodiments of the present invention relate generally to business simulations, and more specifically, to multilevel simulations for healthcare delivery systems. Some embodiments may comprise multilevel modeling and concerned the design of programs or systems that may be self-sustaining and provide a positive return on investment for the overall enterprise.

In the following description, the present invention is described primarily as systems and methods for improving the efficiency of healthcare provision as it relates to prevention and wellness. One skilled in the art will recognize, however, that the invention is not so limited. The system may also be deployed to determine, for example, maintenance schedules for vehicles. In general, the system may be deployed to weigh the cost of many types of maintenance or prevention against the savings such prevention provides.

In the following description, numerous specific details are set forth. However, it is to be understood that embodiments of the present invention may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the present invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In some instances, a computing device may be referred to as a mobile device, mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In other instances, a computing device may be a processor, controller, or a central processing unit (CPU). In yet other instances, a computing device may be a set of hardware components.

A presence-sensitive input device as discussed herein, may be a device that accepts input by the proximity of a finger, a stylus, or an object near the device. A presence-sensitive input device may also be a radio receiver (for example, a WiFi receiver) and processor which is able to infer proximity changes via measurements of signal strength, signal frequency shifts, signal to noise ratio, data error rates, and other changes in signal characteristics. A presence-sensitive input device may also detect changes in an electric, magnetic, or gravity field.

A presence-sensitive input device may be combined with a display to provide a presence-sensitive display. For example, a user may provide an input to a computing device by touching the surface of a presence-sensitive display using a finger. In another example embodiment, a user may provide input to a computing device by gesturing without physically touching any object. For example, a gesture may be received via a video camera or depth camera.

In some instances, a presence-sensitive display may have two main attributes. First, it may enable a user to interact directly with what is displayed, rather than indirectly via a pointer controlled by a mouse or touchpad. Secondly, it may allow a user to interact without requiring any intermediate device that would need to be held in the hand. Such displays may be attached to computers, or to networks as terminals. Such displays may also play a prominent role in the design of digital appliances such as a personal digital assistant (PDA), satellite navigation devices, mobile phones, and video games. Further, such displays may include a capture device and a display.

Various aspects described herein may be implemented using standard programming or engineering techniques to produce software, firmware, hardware, or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

Various systems, methods, and computer-readable mediums may be utilized for improving the efficiency of healthcare provision as it relates to prevention and wellness and will now be described with reference to the accompanying figures.

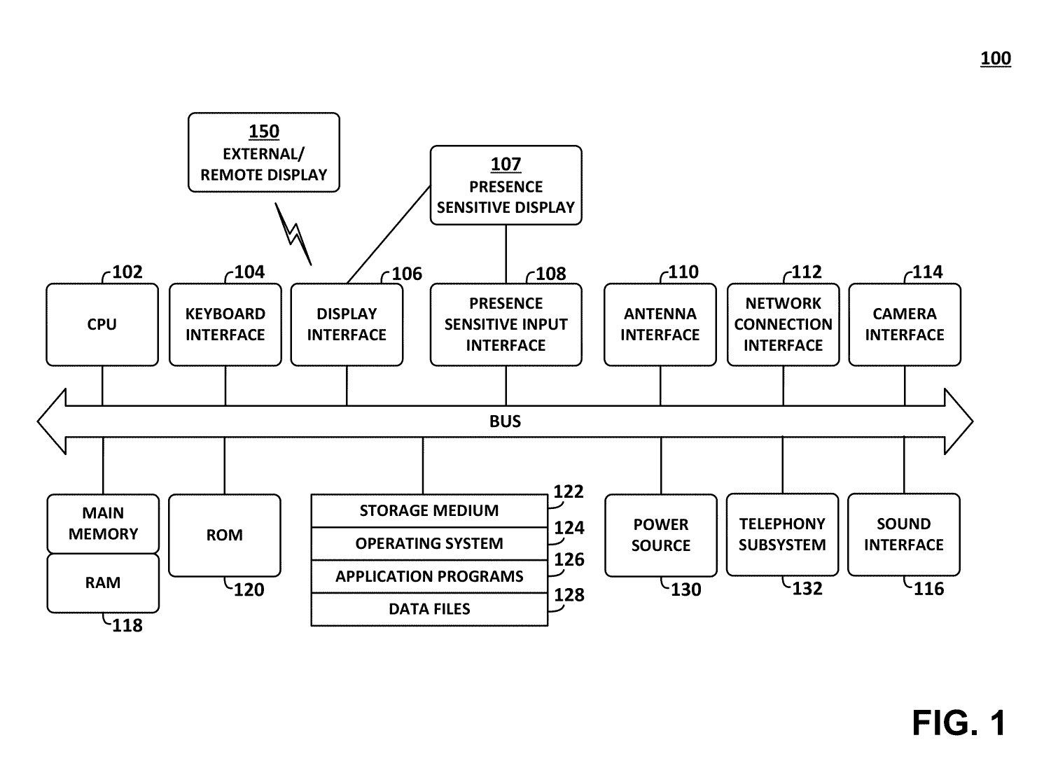

FIG. 1 depicts a block diagram 100 of illustrative computing device architecture, according to an embodiment of the present invention. Certain aspects of FIG. 1 may be embodied in a computing device (for example, a dedicated server computer or a mobile computing device). As desired, embodiments of the present invention may include a computing device with more or less of the components illustrated in FIG. 1. It will be understood that the computing device architecture 100 is provided for example purposes only and does not limit the scope of the various embodiments of the present disclosed systems, methods, and computer-readable mediums.

The computing device architecture 100 of FIG. 1 includes a CPU 102, where computer instructions are processed; a display interface 106 that acts as a communication interface and provides functions for rendering video, graphics, images, and texts on the display. According to certain some embodiments of the present invention, the display interface 106 may be directly connected to a local display, such as a touch-screen display associated with a mobile computing device. In another example embodiment, the display interface 106 may be configured for providing data, images, and other information for an external/remote display that is not necessarily physically connected to the mobile computing device. For example, a desktop monitor may be utilized for mirroring graphics and other information that is presented on a mobile computing device. According to certain some embodiments, the display interface 106 may wirelessly communicate, for example, via a Wi-Fi channel or other available network connection interface 112 to the external/remote display.

In an example embodiment, the network connection interface 112 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof

The computing device architecture 100 may include a keyboard interface 104 that provides a communication interface to a keyboard. In one example embodiment, the computing device architecture 100 may include a presence-sensitive display interface 107 for connecting to a presence-sensitive display. According to certain some embodiments of the present invention, the presence-sensitive display interface 107 may provide a communication interface to various devices such as a pointing device, a touch screen, a depth camera, etc. which may or may not be associated with a display.

The computing device architecture 100 may be configured to use an input device via one or more of input/output interfaces (for example, the keyboard interface 104, the display interface 106, the presence sensitive display interface 107, network connection interface 112, camera interface 114, sound interface 116, etc.) to allow a user to capture information into the computing device architecture 100. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 100 or may be a separate device. For example, the input device may be an accelerometer, a magnetometer, a digital camera, a microphone, and an optical sensor.

Example embodiments of the computing device architecture 100 may include an antenna interface 110 that provides a communication interface to an antenna; a network connection interface 112 that provides a communication interface to a network. According to certain embodiments, a camera interface 114 is provided that acts as a communication interface and provides functions for capturing digital images from a camera or other image/video capture device. According to certain embodiments, a sound interface 116 is provided as a communication interface for converting sound into electrical signals using a microphone and for converting electrical signals into sound using a speaker. According to example embodiments, a random access memory (RAM) 118 is provided, where computer instructions and data may be stored in a volatile memory device for processing by the CPU 102.

According to an example embodiment, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to an example embodiment, the computing device architecture 100 includes a storage medium 122 or other suitable type of memory (e.g., RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 124, application programs 126 (including, for example, a web browser application, a widget or gadget engine, and or other applications, as necessary) and data files 128 are stored. According to an example embodiment, the computing device architecture 100 includes a power source 130 that provides an appropriate alternating current (AC) or direct current (DC) to power components. According to an example embodiment, the computing device architecture 100 includes a telephony subsystem 132 that allows the device 100 to transmit and receive sound over a telephone network. The constituent devices and the CPU 102 communicate with each other over a bus 134.

According to an example embodiment, the CPU 102 has appropriate structure to be a computer processor. In one arrangement, the CPU 102 may include more than one processing unit. The RAM 118 interfaces with the computer bus 134 to provide quick RAM storage to the CPU 102 during the execution of software programs such as the operating system application programs, and device drivers. More specifically, the CPU 102 loads computer-executable process steps from the storage medium 122 or other media into a field of the RAM 118 in order to execute software programs. Data may be stored in the RAM 118, where the data may be accessed by the computer CPU 102 during execution. In one example configuration, the device architecture 100 includes at least 125 MB of RAM, and 256 MB of flash memory.

The storage medium 122 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 122, which may comprise a machine-readable storage medium.

According to one example embodiment, the term computing device, as used herein, may be a CPU, or conceptualized as a CPU (for example, the CPU 102 of FIG. 1). In this example embodiment, the computing device may be coupled, connected, or in communication with one or more peripheral devices, such as display, camera, speaker, or microphone.

In some embodiments of the present invention, the computing device may include any number of hardware or software applications that are executed to facilitate any of the operations. In some embodiments, one or more I/O interfaces may facilitate communication between the computing device and one or more input/output devices. For example, a universal serial bus port, a serial port, a disk drive, a CD-ROM drive, or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various embodiments of the present invention and/or stored in one or more memory devices.

One or more network interfaces may facilitate connection of the computing device inputs and outputs to one or more suitable networks or connections; for example, the connections that facilitate communication with any number of sensors associated with the system. The one or more network interfaces may further facilitate connection to one or more suitable networks; for example, a local area network, a wide area network, the Internet, a cellular network, a radio-frequency network, a Bluetooth-enabled network, a Wi-Fi-enabled network, a satellite-based network, any wired network, any wireless network, etc., for communication with external devices or systems.

Conventional healthcare systems often compensate providers on a per-service basis. In other words, a healthcare provider may be paid for activity rather than efficacy. This circumstance, coupled with the litigious nature of modern society, may lead healthcare providers to perform unnecessary procedures to increase profitability at the cost of efficiency. A non-designed conversion to a results-based system, however, may fail to address the complexity of our healthcare system and erroneously assume that all changes to the system will effect their expected result. Moreover, making such a drastic change in real-time may prove to be economically disastrous. What is needed, therefore, is a system that may enable parameters within complex systems to be varied and simulated to arrive at a potentially ideal configuration, or hybrid, of existing and imagined systems, as appropriate.

Accordingly, some embodiments of the present invention may facilitate the modeling of complex multilevel organizations. Multilevel modeling techniques are discussed herein and applied to an employer-based prevention and wellness program. An important decision in this application concerns the possibility of changing from a “capitated” system of payment, i.e., where a set or subset of people pay a fixed amount for units of healthcare, to an outcomes-based payment system. For prevention and wellness in healthcare, the outcomes of interest relate to, for example, risk reductions. As discussed herein below, risks may include, for example and not limitation, diabetes mellitus (DM) and coronary heart disease (CHD). Of course, other preventable or semi-preventable diseases and ailments may be included such as, for example and not limitation, cancer, stroke, heart attack, arthritis, and lung disease.

These risk reductions may be assessed and validated using clinical measures as inputs to disease incidence models developed using well-recognized national data sets. More generally, the techniques described in this paper are concerned with the design of prevention and wellness programs that are self-sustaining while providing a positive return on investment for the overall enterprise. Embodiments of the present invention thus include applying a new approach to organizational simulation to prevention and wellness.

### 1.1 Driving Forces

There are several drivers moving the industry towards healthcare delivery reform, including insurance reform, which is now underway. In the healthcare reform, the emphasis will likely shift from covering more people to changing delivery practices. Employees' unhealthy lifestyles are increasing the incidence and cost of chronic diseases, for example, leaving employers to absorb both increased healthcare costs and the costs of lost productivity. Accordingly, healthcare may shift from specific reactive treatment to comprehensive preventative plan.

Healthcare providers may also have to adapt to new revenue models. They may be paid for outcomes, for example, rather than procedures. As a result, improved quality and lower costs will be central. To differentiate between profitable and unprofitable plans, providers will need to understand and manage their costs at each level of each process.

Responsibility for outcomes will likely lead to a more networked organization to enable access to the most cost-effective capabilities needed to ensure outcomes. The physician, one of the more expensive assets in the system, will likely increasingly be focused on the most complex activities. This leaves lower-paid professionals to perform functions requiring less training Contracting, partnering, and managing such a network model, therefore, will be increasingly central—and likely more risky in the sense that outcomes will determine sustainability. Due to increases competition and reduced margins, there may be little, or no, revenue without consistently positive outcomes.

The transformation of health delivery will likely involve many decisions at all levels of the system. In a preferred embodiment, these decisions should be evidence-based with data and analytics being central to decision making The tendency to base decisions on anecdotal experiences, as in the old system will wane, and more rigorous approaches will have to be adopted.

### 1.2 Types of Decisions

An overarching issue concerns how best to organize in response to the driving forces summarized above. It can be gleaned from some of the best performers in health delivery, as well as other domains, that an advantageous approach is to focus on the processes in which healthcare is provided to people. These processes can include, for example and not limitation, prevention and wellness, outpatient chronic disease management, and inpatient care delivery.

Thinking in terms of processes is different than thinking in terms of departments and functions or specialties. A process orientation may focus, for example, on how value is provided to those receiving health services. Value may be measured with respect to, for example, health outcomes, service prices, and service levels. A process orientation may cause providers to see themselves in terms of value streams or networks that create desired outcomes for customers with acceptable prices and service levels.

Given this orientation, central decisions may be associated with mapping and optimizing processes related to the flow of care. This includes deciding on the sequencing, timing, allocation, and scheduling of process steps, among other things. Because not all people have the same needs, decisions must be made about stratifying patient flows according to risk levels and creating the means for reducing risks (i.e., increasing wellness).

There are also decisions surrounding the scaling of the delivery system, such as ramping up new offerings from a pilot program to a much larger patient population. Related decisions concern the extent to which customized plans may be delivered by standardized processes. In other words, can customization be delivered at a large scale?

Changing revenue models may present substantial challenges for healthcare providers. Adapting to payment for outcomes rather than fee-for-service models, for example, means that providers have to scrutinize processes to determine where value is most added. When payers no longer reimburse costs, for example, then providers must understand costs, as opposed to simply passing them on as they often do now. Many procedures will have to be streamlined, while others will need to be delivered in a nontraditional setting or by alternative personnel. Many procedures are likely to be eliminated or shifted to the patients via various forms of e-visits.

The impacts of reduced Medicare/Medicaid reimbursements will also require decisions about who to serve and how to serve them. Some providers already limit the number of Medicare/Medicaid patients they serve. They may also decide to use very streamlined processes, effectively providing low-end services for those who cannot afford high-end services. The many hospital providers who have closed their emergency rooms and physicians who have changed to a concierge-type practice are clear indicators of this trend.

Another class of decisions concerns optimizing employer-based programs. Such programs are increasingly focused on prevention and wellness, targeting employees with high risks of, for example, DM or CHD. Many employers provide in-house clinics, for example, to provide convenient low-cost care to employees, typically with the management and staffing outsourced.

### 1.3 Complexity of Decision Making

Healthcare decisions are rife with complexity. As discussed below, one source of complexity may be the interaction between different levels of the system. Government incentives and restrictions (e.g., regulations) also affect enterprise strategies for providers, payers, and employers, including suppliers such as medical device and pharmaceutical companies. These enterprise strategies, in turn, influence the management of the universe of organizations involved across the system. Organizational management, in turn, affects process operations and health delivery. Some embodiments of the present invention, therefore, may attempt to provide evidence-based decision making at all of these levels.

Other sources of complexity may include alternative policies (on a wide range of issues), the delay or uncertainly of outcomes (e.g., the returns on prevention), and the difficulty of understanding higher-order and/or unintended consequences. The number of independent businesses that interact in multiple, and often conflicting, ways is also an enormous source of complexity. These results in many poorly understood and poorly managed interactions among the aforementioned system levels.

Certain embodiments of the present invention, therefore, may comprise multilevel simulations to cope with this complexity by enabling timely exploration of likely outcomes before deployment. In an example embodiment, people may interact with these simulations to explore a wide range of variations in both organization and process designs. In this manner, users can determine the sensitivity of health outcomes and financial performance to variations in key parameters. In some embodiments, the interactions may occur via large-screen displays with various dashboard controls and visualizations. One or more of the user-facing dashboard and simulation may be hosted or performed by a computing device or network thereof, for example, having a portion of the architecture depicted in FIG. 1.

### 2. Enterprise of Health Delivery

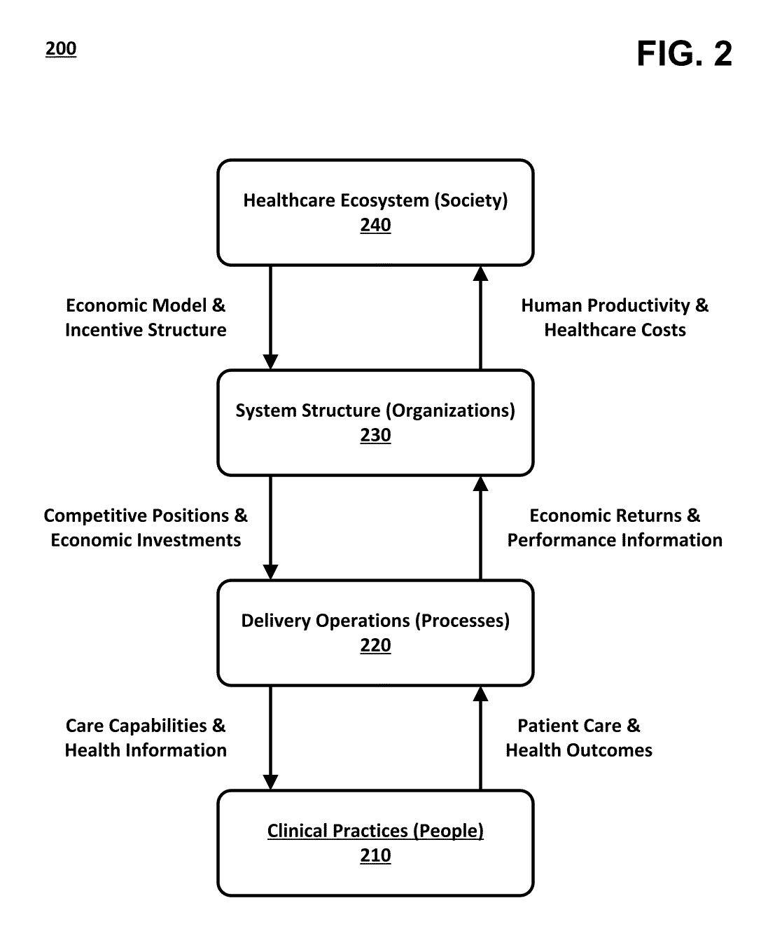

FIG. 2 depicts a flow diagram 200 of a healthcare delivery business, according to an embodiment of the present invention. The efficiencies that may be gained at the lowest level (e.g., clinical practices 210) are generally limited by capabilities and information provided by the next level (e.g., delivery operations 220). As discussed previously, functionally organized practices, for example, may be much less efficient than those where delivery is organized around care processes.

Similarly, the efficiencies that may be gained in operations can be limited by the nature of the level above (e.g., system structure 230). Functional operations tend to be driven by organizations structured around specialties (e.g., anesthesiology and radiology). When the different specialties are actually different businesses with independent economic objectives, however, then process-oriented thinking can become quite difficult. At the extreme, if a business' sole asset is an expensive magnetic resonance imaging system, then the objective is to employ it as often as possible to satisfy the individual business needs even if that increases overall costs of care. This is an example of “sub-optimization” within a system.

Of course, efficiencies in system structure may be somewhat limited by the healthcare ecosystem in which organizations operate, which sets the “rules of the game.” If, for example, the rules attach no value to healthy, productive people, then the focus will be on providing acceptable service over the short term at minimum cost. Because the definition of “acceptable” is inherently vague, the greatest weight is usually placed on minimizing the use of the most expensive procedures and cost control.

The conventional fee-for-service model central to healthcare in the United States ensures that provider income is linked to activities rather than outcomes. The focus on disease and restoration of health rather than wellness and productivity ensures that healthcare expenditures will be viewed as costs rather than investments. Recasting “the problem” in terms of outcomes characterized by wellness and productivity may enable identification and pursuit of efficiencies that could not be imagined within our current frame of reference.

### 3. Application: Employer-Based Prevention and Wellness

Some embodiments of the present invention relate to applying a multilevel model to projecting the economic benefits of employer-based prevention and wellness. But, is the cost of prevention and wellness worth it in terms of downstream savings of healthcare costs and productivity losses? The general answer is often “yes,” but employers may be more interested in a specific answer for their population of employees and covered lives, not a general answer for all people. Depending on the nature of their businesses, these populations may be substantially different.

It is useful to note that economic valuation of investments in people—in terms of training, education, safety, health, and work productivity—often indicates a strong return on investment (ROI), with one central caveat: If the investing entity is the same entity that realizes the returns, the economic case is often compelling. If the two entities differ (e.g., companies invest and the employee's next employer or the federal government sees lower costs), on the other hand, then the investor tends to see this outlay as a cost and may try to minimize it.

Another issue is employees' compliance with prevention and wellness programs. Men in particular often avoid routine medical examinations. Hence, health risks are often unknown until the onset of disease. These, and a variety of other reasons, make it difficult to ensure the returns of proven prevention and wellness programs.

### 3.1 Model Levels

In some embodiments, as shown in FIG. 2, a model can contain four levels: the ecosystem level 240, the organization level 230, the process level 220, and the people level 210. Each level may introduce a corresponding conceptual set of issues and decisions for both the payer and the provider. In the example case, described below, the Human Resources (HR) department at Emory University is the payer responsible for healthcare costs for university employees and the Predictive Health Institute (PHI) is the provider focused on prevention and maintenance of employee health.

The ecosystem level 240 may enable decision makers to test different combinations of policies from the perspective of HR. For instance, this level can determine the allocation of payment to PHI based on a hybrid capitated, or pay-for-outcome, formula. It may also involve choices of parameters such as, for example and not limitation, projected healthcare inflation rate, general economy inflation rate, and discount rate that affect the economic valuation of the prevention and wellness program. A major concern for HR is achieving a satisfactory ROI on any investments in prevention and wellness.

The concerns at the organization level 230 may include, for example, the economic sustainability of PHI—i.e., its revenue must be equal to or greater than its costs. To achieve sustainability, therefore, PHI must appropriately design its operational processes and rules. Important to this process are the levels used to stratify the participant population and the assessment and coaching processes employed for each strata of the population, among other things. Other organization-level considerations may include the growth rate of the participant population, the age ranges targeted for growth, and the program duration before participants are moved to “maintenance.”

The process level 220 may represent the daily operations of PHI. Participants may visit PHI every 6 to 12 months, for example, where seven health partners employed by PHI perform assessments, work with participants to set health goals, and perform follow-up calls or emails to monitor participants and encourage them to follow their plan. All these activities may be preferably captured in the process level. The costs of these activities can then be aggregated and reflected in the organization level as the costs of running PHI. The people level 210 may be the replication of the actual population of PHI participants.

### 3.2 Emory/Georgia Tech Predictive Health Institute

PHI is a joint initiative of Emory University and the Georgia Institute of Technology. Within PHI, the Center for Health Discovery and Well Being™ (CHDWB) is an experimental project focusing on health in its broadest context, exploring novel biomarkers that predict health or its loss, and affecting lifestyles in ways that favorably effect health risks. A goal of the center is to define, predict, and maintain health throughout the human life span.

The center is intended to be a health-focused facility that serves essentially healthy people and does not deliver traditional medical care. The initial test group was a random sample of fully employed, productive, Emory University personnel who are 60% female, 58% white (non-Hispanic), 24% African American, 3% Hispanic, 15% Asian, and less than 1% other. Inclusion criteria were male or female employees aged 18 and older and absence of hospitalization in the previous year except for accidents.

The application of the example multilevel model focused on the roughly 700 people in this group and their risks of DM and CHD. Each person's risk of each disease was calculated using Wilson's DM and CHD risk models based on the Framingham data set using CHDWB's initial individual assessments of blood pressure, fasting glucose level, etc. Subsequent assessment data were used to estimate annual risk changes as a function of initial risks of each disease.

Decreased risks may be quantified as increased average times until disease onset. This generally results in cost savings in terms of additional years without the costs of treating the disease and lost productivity due to absenteeism (and presenteeism). Annual costs of healthcare and productivity losses for DM and CHD were based on national sources (e.g., American Diabetes Association), as well as, where possible, analysis of Emory claims data.

Roughly 700 participants were enrolled in the experimental prevention and wellness program. Each of them had various assessment measurements recorded such as blood pressure, fasting glucose level, etc. However, because the program was an experimental project, approximately 2,000 variables were also measured at each assessment encounter. Each participant was inserted into the model as an agent. Based on the assessment measurements, the risk of developing DM or CHD can be computed for each agent. Then, total healthcare costs can be estimated for the participant's remaining life based on his or her risk level for each disease. The reduced amount of aggregated total healthcare cost achieved by PHI is represented as an ecosystem-level 240 benefit to the HR organization.

The system was implemented as a four-level model in AnyLogic, version 6.7. Runs of the multilevel simulation can be set up using a suitable graphical user interface (GUI), such as the dashboard shown in FIG. 2. Beyond the decision variables discussed above, decision makers can also decide what data source to employ to parameterize the models, e.g., data from the American Diabetes Association (ADA) and the American Heart Association (AHA) or data specific to Emory employees. Decision makers can choose to only count savings until age 65 or to also project postretirement savings.

The bottom half of the dashboard enables inputs from organization-level decision makers—in this case, PHI employees. Beyond the variables mentioned above, these decision makers can choose how to stratify the participant population into low- and high-risk groups for each disease. Once PHI employees choose a level on the risk threshold slider, a set point appears on the percent risk reduction slider that represents what PHI is actually achieving based on analysis of their ongoing assessment data. Decision makers may then choose to operate at the set point by moving the slider to this point, or they can explore the consequences of larger or smaller risk reductions.

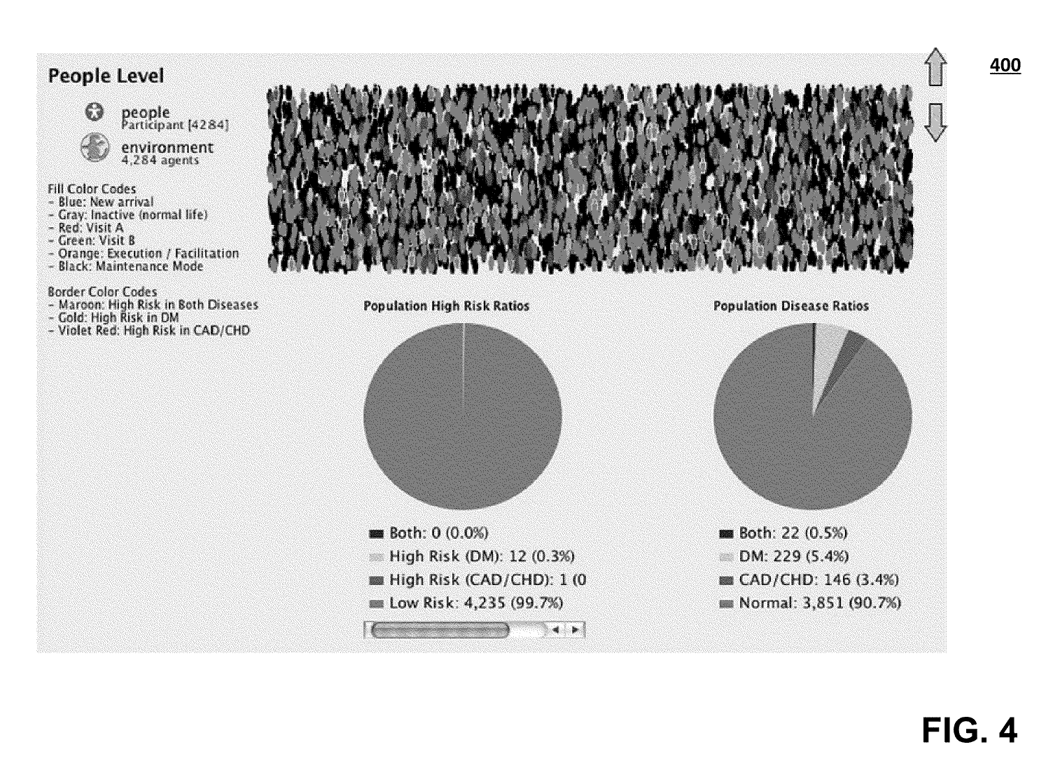

FIG. 4 depicts a people level 400 of the multilevel simulation dashboard, according to an embodiment of the present invention. The people level may be represented as an agent-based simulation. In the example model, each agent represents an Emory employee, with an assessment record and computed risks levels for DM and CHD. The color coding shows the status of each employee (e.g., experiencing first visit, interacting with his or her health partner, carrying on with everyday life). This level can also show the current distribution of risk levels in the population. Note that attrition was represented by actual participants no longer appearing in the clinical data set, but the percentage of attrition was very small.

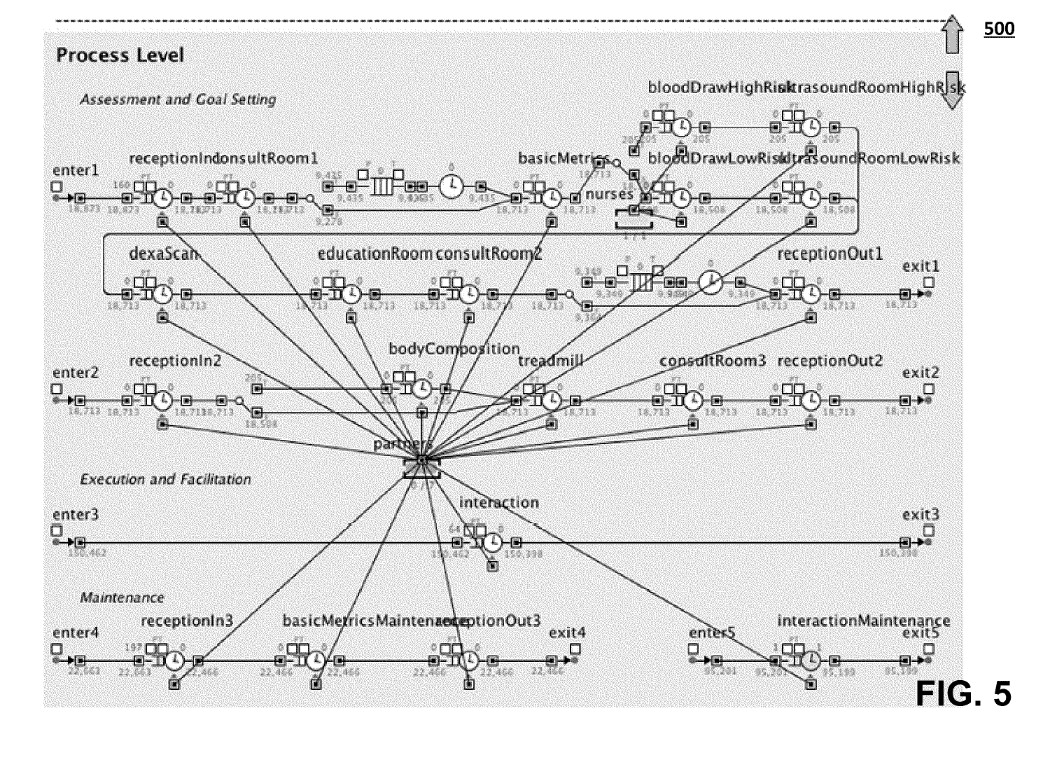

FIG. 5 depicts a process level 500 of the multilevel simulation dashboard, according to an embodiment of the present invention. Table 1 provides definitions of the terms in FIG. 5. These processes represent how participants flow through the care system for assessments, plan development, and goal setting at PHI; the execution and facilitation of plans away from PHI; and the maintenance mode once the goals are achieved, among other things. The discrete-event model at this level may simulate, for example, how participants consume the capacities of PHI, both in terms of time and money.

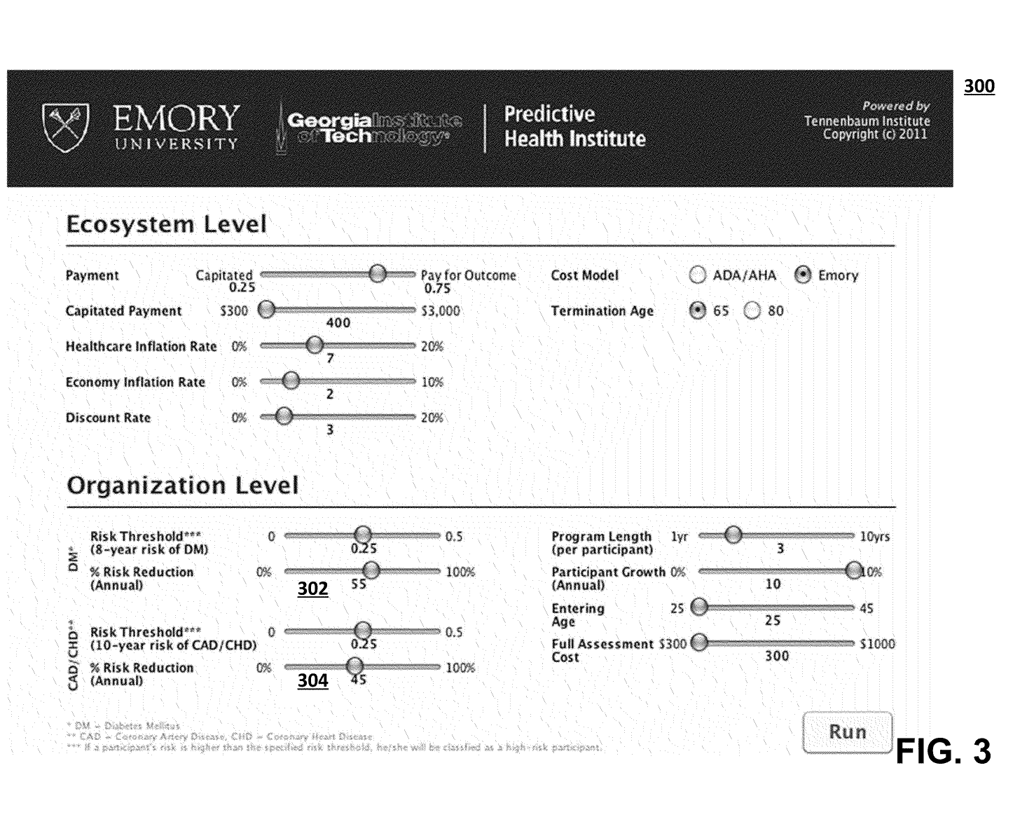

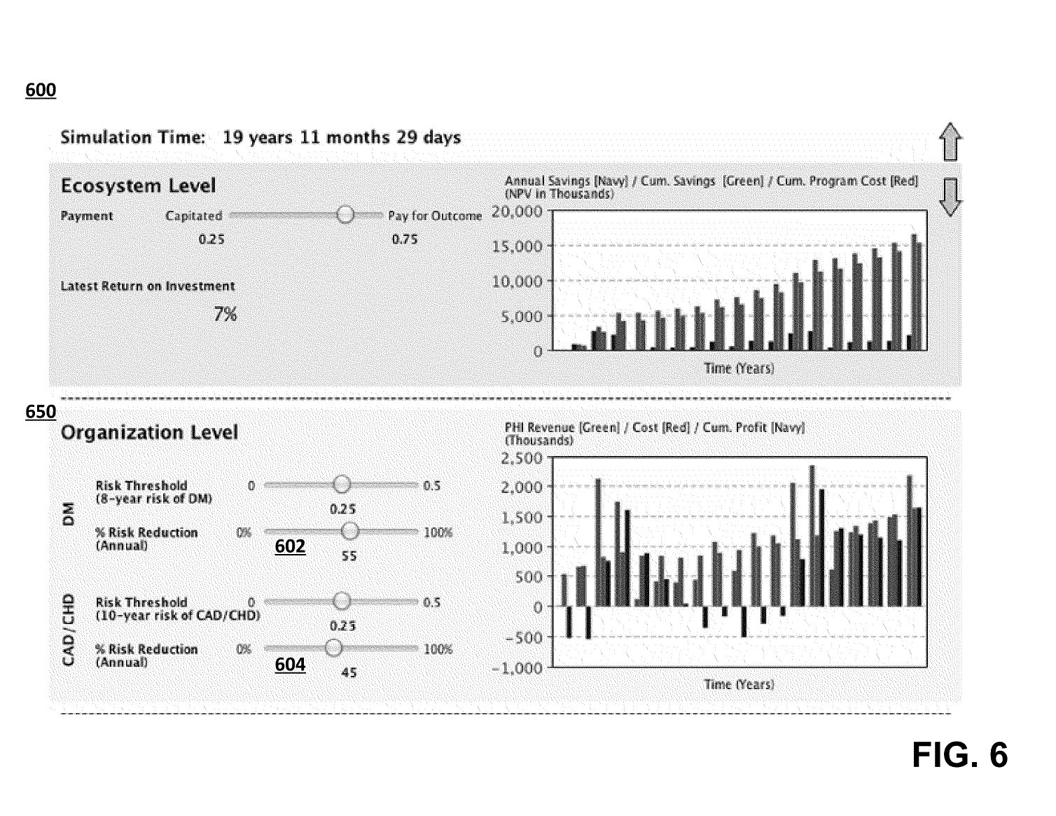

FIG. 6 depicts ecosystem 600 and organization levels 650 of the multilevel simulation dashboard, according to an embodiment of the present invention. The provider organization, in this example, PHI, may decide how to stratify participant flows and seeks to have revenues equal or exceed costs. The payer organization, HR, on the other hand, may set the rules of the game, as depicted on the dashboard in FIG. 3. HR's ROI from PHI's services is shown in net present values using the discount rate shown in FIG. 3. The returns achievable with various combinations of the parameters in FIG. 3 are discussed below in Section 3.4.

TABLE 1
Definitions of Process Steps

| Process | Step | Activity |
|---|---|---|
| Assessment and goal setting (“A” visit) | Reception | Check-in and meet partner |
| | Consult room | Informed consent, preliminary |
| | | questionnaire |
| | Changing room | Change clothes (optional) |
| | Basic metrics | Height, weight, blood pressure |
| | | measurements |
| | Lab | Blood draw (depending on risk |
| | | level) |
| | Ultrasound room | Ultrasound scanning (depending |
| | | on risk level) |
| | Dexa scan | Body composition |
| | Education room | Surveys |
| | Consult room | Mini-cognitive exam |
| | Changing room | Change clothes (optional) |
| | Reception | Check-out |
| Assessment and goal setting (“B” visit) | Reception | Check-in |
| | Body composition | Skinfold calipers, waist-to-hip |
| | | measurements (optional/only |
| | | for high-risk participants) |
| | Treadmill | Maximal oxygen consumption |
| | Consult room | Review results, create health |
| | | plan |
| | Reception | Check-out |
| Execution and facilitation | Interaction | Phone call or email follow-ups |
| Maintenance (visit) | Reception | Check-in |
| | Basic metrics | Height, weight, blood pressure |
| | | measurements |
| | Reception | Check-out |
| Maintenance (follow-up) | Interaction | Phone call or email follow-ups |

### 3.3 Parameter Estimation

### 3.3.1 Projected Disease Risks

The annual risk reductions achievable are important inputs, as shown in both FIG. 3 302/304 and FIG. 6 602/604. For DM, as noted earlier, Wilson's model may be used to project eight-year risk. The Wilson model utilizes fasting glucose level, body mass index, high-density lipoprotein (HDL)-C level, parental history of DM, triglyceride level, and blood pressure to estimate the probability a person will develop DM in the next eight years.

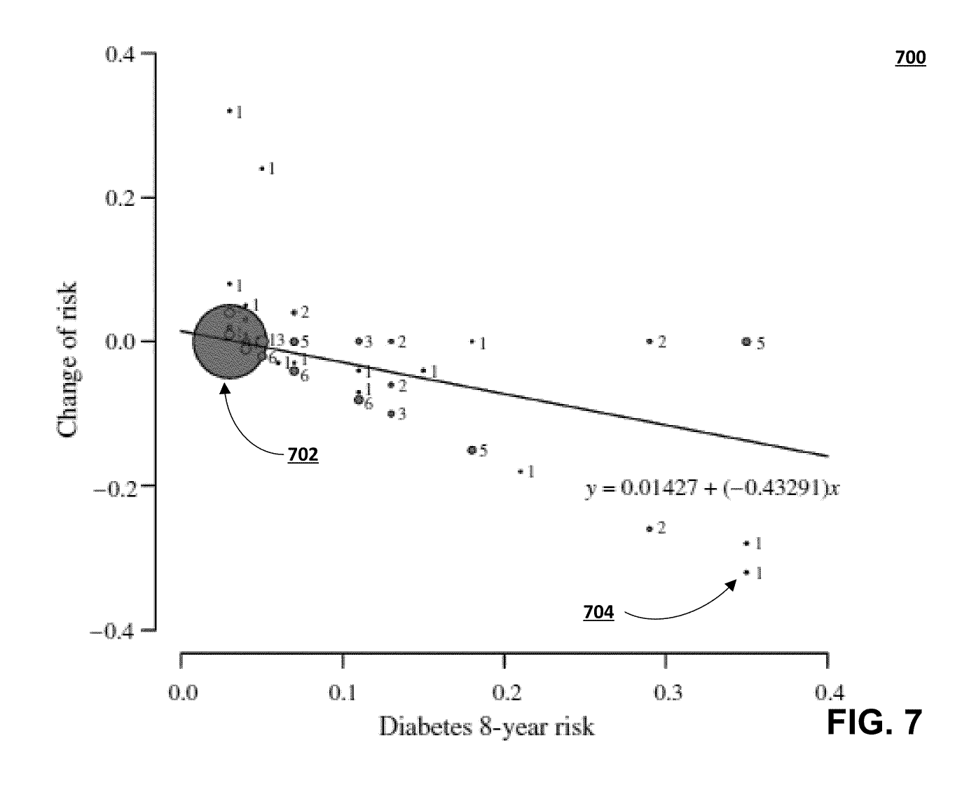

FIG. 7 depicts a graph 700 of reduction of diabetes mellitus risks for users due to the system, according to an embodiment of the present invention. FIG. 7 shows the relationship between the magnitudes of risk reduction over the PHI enrollment period versus initial risk levels when each person joined PHI. Most participants had a minimum level of risk, so they have a corresponding a minimal potential for risk reduction. The large red circle 702 near the origin represents these low-risk people. A relatively small number of people achieved substantial risk reductions. The dot 704 in the bottom right corner, for example, represents a participant who came in with the highest possible risk and eliminated most of this risk during PHI enrollment. Other group participants, who had various risk levels, achieved little reduction, represented by the dots parallel to the x axis.

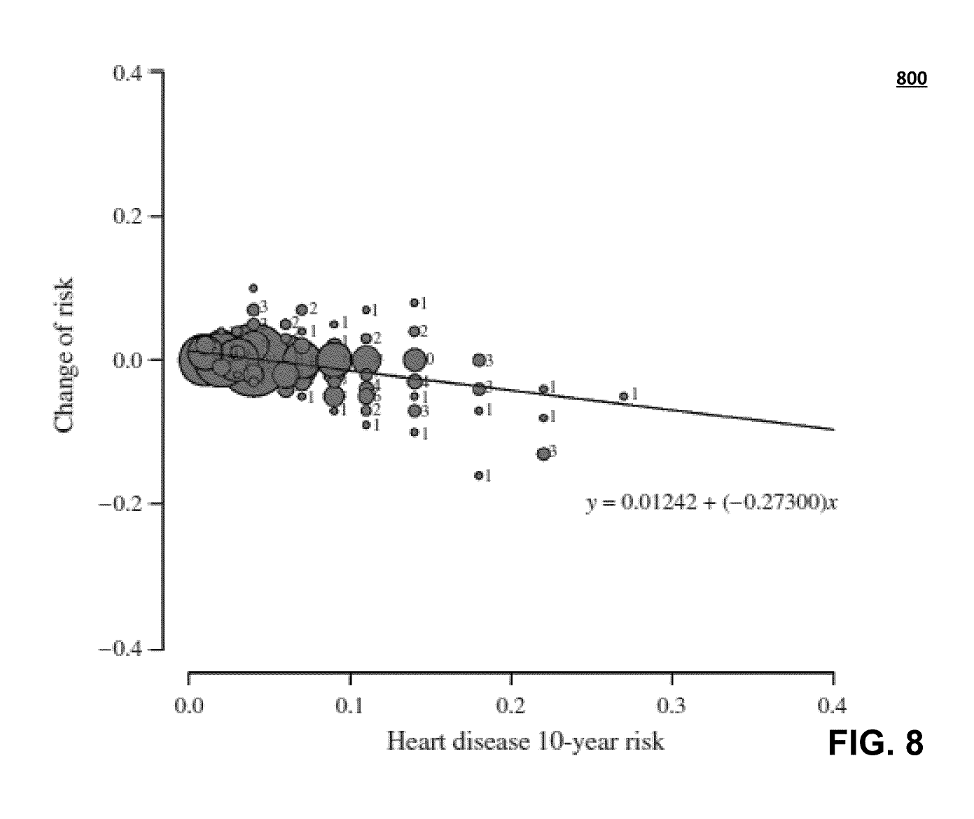

FIG. 8 depicts a graph 800 of reduction of risk of coronary heart disease for users due to the system, according to an embodiment of the present invention. Regarding CHD, another model developed by Wilson and his colleagues may be employed. This model uses age, low-density lipoprotein-C level, cholesterol level, HDL-C level, blood pressure, DM incidence, and smoking behavior as inputs to compute predictions of the probability of CHD in the next ten years. Note that, as participants' age, the risk of CHD increases even when other input variables do not change. FIG. 8 shows the relationship between the magnitudes of CHD risk reduction over the PHI enrollment period versus initial risk levels when each person joined PHI. These trend lines were fit to the whole data set, even though most participants had no changes of risk levels over time. As a result, apparent outliers had little impact on the fits.

The risk probabilities, “P8” for DM and “P10” for CHD, denote the probability of DM incidence in the next 8 years and the probability of CHD incidence in the next ten years, i.e., the outputs of Wilson's models. These multiyear probabilities can be decomposed into single-year probabilities, “P1.” The average time until disease onset may then be calculated as Time=1/P1, which assumes that disease onset is a Markov process. As risks reduce over time for any particular participant, P1 decreases, and hence the predicted time until disease onset increases. These increases in time represent downstream savings due to healthcare costs avoided by delaying the onset of DM and/or CHD. Note that this time may increase beyond the life expectancy of the subject.

### 3.3.2 Projecting Costs of Risk Reduction

The costs of achieving these risk reductions may be those associated with operating the process level 220 of the model. Each step may be estimated to consume an amount of time, determined from a random draw from a triangular distribution with average, minimum, and maximum estimated for each process step. Time costs may then be estimated based on an hourly rate for personnel, equipment, and facilities, including maintenance and other costs. Investments in equipment and facilities can be amortized over the number of simulated years. These costs may be increased over time using the economic inflation rate set in the dashboard shown in FIG. 3.

### 3.3.3 Projected Downstream Costs Avoided.

Projected healthcare costs incurred by simulated individuals diagnosed with DM or CHD may be determined in at least two ways. The first approach is based on national cost studies published by the ADA and the AHA. The second approach is based on Emory claims data to estimate costs specific to the population from which PHI participants were drawn. Table 2 contains cost estimates produced by both methods and costs resulting from loss of productivity, which may be calculated as follows.

In this example, the cost of DM in the United States was obtained from a 2008 report by the ADA (American Diabetes Association 2008). The report estimated, for example, $116 billion in medical expenditures and $31.3 billion in reduced productivity (excluding mortality) during 2007. Given the estimate of 17.5 million people with diagnosed DM in 2007, per-capita costs may be estimated as $6,649 in medical expenditures and $1,790 in reduced productivity. The report also estimated per-capita medical expenditures of $3,808 for ages 0-44, $5,094 for ages 45-64, and $9,713 for ages 65 and older. In the simulation, age-appropriate values may be used for individuals with DM when “ADA/AHA” is selected under “Cost Model.”

In this case, the cost of CHD in the United States was drawn from a 2010 statistical update and a 2011 forecast by the AHA. The statistical update estimated $96.0 billion in direct medical costs and $11.3 billion in lost productivity due to morbidity during 2010. Using the projected 2010 CHD prevalence of 8.0% from the forecast, and the 2010 United States population of 308.7 million, these costs were spread among 24.7 million people (U.S. Census Bureau 2011). This yielded per-capita values of $3,887 in medical costs and $457 in lost productivity. These values may be used in the simulation for all individuals with CHD when “ADA/AHA” is selected under “Cost Model”; however, costs by age range were not available in the statistical update.

In addition to the national cost estimates for DM and CHD described above, estimates specific to the Emory population were also prepared from a database of all claims paid under Emory's Aetna-administered health plan from October 2007 through December 2010. This process began by identifying individuals treated under appropriate diagnosis codes from the International Classification of Diseases, 9th Revision (ICD-9). DM patients were defined as those who received at least two procedures under an ICD-9 code starting with 250 (250.*), excluding codes ending in 1 or 3 (250.*1 or 250.*3) to avoid inclusion of treatments for DM Type I. CHD patients were defined as those who received at least one procedure under an ICD-9 code starting with 410, 411, 412, 413, or 414 (410.*, 411.*, 412.*, 413.*, or 414.*).

TABLE 2
Annual Per-Capita Costs (U.S. Dollars) of Diabetes and Coronary Heart Disease

| | Diabetes Mellitus | | Coronary heart disease | |
|---|---|---|---|---|
| | Medical cost | Productivity Cost | Medical cost | Productivity Cost |
| National Estimates | | | | |
| All ages | 6,649 | 1,790 | 3,887 | 457 |
| Ages 0-44 | 3,808 | 1,790 | 3,887 | 457 |
| Ages 45-64 | 5,094 | 1,790 | 3,887 | 4570 |
| Ages 65+ | 9,713 | 0 | 3,887 | |
| Emory Estimate | | | | |
| All ages | 3,762 | 1,790 | 6,523 | 457 |
| Ages 0-44 | 3,043 | 1,790 | 4,350 | 457 |
| Ages 45-64 | 3,492 | 1,790 | 5,905 | 457 |
| Ages 65+ | 4,193 | 0 | 6,705 | 0 |

After patient sets are identified for each disease, total medical costs may be determined by summing coinsurance amount, copay amount, deductible amount, net payment amount, and third-party amount for all procedures and prescriptions administered to each patient in the set. Costs can be annualized, for example, by determining the total cost per year of eligibility for each patient. To determine the portion of total costs attributable to each disease and its complications, baseline groups can be constructed from the set of individuals who received treatment for neither DM nor CHD and the median age of each patient can be set equal to the median age of its baseline. The increase in annualized costs above the baseline can then be used as the marginal cost of each disease. Given the small patient population in some comparisons, however, median costs can be used (e.g., for the Emory population cost estimates). This serves to reduce the impact of a few patients with extraordinarily high costs and provided safe but conservative estimates.

Based on the methods described above, the per-capita DM costs for the Emory population were $3,762 for all ages, $3,043 for ages 0-44, $3,492 for ages 45-64, and $4,193 for ages 65 and older. Claims-based CHD costs were $6,523 for all ages, $4,350 for ages 0-44, $5,905 for ages 45-64, and $6,705 for ages 65 and older. The claims-based cost figures given here are used in the simulation when “Emory” is selected under “Cost Model.” Further, all of the above costs may be increased in future years using a healthcare inflation rate set in the dashboard shown in FIG. 3.

### 3.3.4 Projecting Returns on Investment

PHI may incur costs of operating its processes to reduce the risks of DM and CHD for its population of participants. The resulting risk reductions may delay the onset of these diseases for participants, often beyond their projected life span. This may result in cost avoidance, both for treatment of these diseases and lost work productivity. This savings may yields future cash flow to HR that enables them to provide revenue to PHI. Because these savings will occur in the future and the investment must be made now, however, one needs to consider factors such as expected inflation. The result for PHI and HR consists of two timed series for each, one for costs and one for revenues. As expected, the difference between revenues and costs represents profit or loss. The net present value of this time series is then calculated using the discount rate shown in FIG. 3. The ROI shown in FIG. 6 may then be calculated from the latest (most recent year) ratio of savings to costs.

### 3.4 Representative Results

The dashboard 200 may enable a wide range of users (e.g., decision makers, policy analysts, organizational designers) to change model parameters and view the simulation outcomes in real time. Model parameters have many complex interdependencies, however, that may lead to non-intuitive outcomes for PHI and HR. Given the number of parameters, it could be quite time consuming for a user to manually vary parameter configurations to evaluate all possible outcomes. To provide a comprehensive view of the interaction dynamics of parameters and resulting economic outcomes, therefore, an experimental simulation may be conducted using a parameter variation approach. The experimental design is depicted in Table 3. In this example, the total number of unique configurations is 189,000. Each configuration can be replicated multiple times (e.g., 100 times) to ensure accurate results. For each configuration, multiple economic performance measures can be tracked. In this example, three economic performance measures were captured: the average profit to PHI, the ROI to Emory HR, and the aggregate economic gain to Emory (i.e., the sum of PHI profits and HR returns).

TABLE 3
Experimental Design

| Level | Parameter | Type | Parameter configuration |
|---|---|---|---|
| Ecosystem | Cost model | Fixed | Emory |
| | Termination age (years) | Fixed | 65 |
| | Payment ($) | Vary | pmt = (0, 0.25, 0.5, . . . , 1.0) |
| | Capitated payment ($) | Vary | cap = (300, 700, 1,100, . . . , |
| | | | 2,700) |
| | Healthcare inflation (%) | Vary | h = (3, 7, 11) |
| | Economy inflation (%) | Vary | e = (2, 4, 6, 8) |
| | Discount rate (%) | Vary | i = (3, 7, 11) |
| Organization | DM (% risk reduction) | Fixed | DM = (0.25, 0.55) |
| | CHD (% risk reduction) | Fixed | CHD = (0.25, 0.45) |
| | Program length (years) | Vary | l = (1, 2, . . . , 5) |
| | Participant growth (%) | Vary | g = (5, 10) |
| | Entering age (years) | Vary | age = (25, 30, 35) |
| | Full assessment cost ($) | Vary | costa = (200, 400, . . . , |
| | | | 1,000) |

“Economically attractive” configurations, under which PHI is a sustainable organization and Emory HR also has a positive ROI, are described below. Examples of each attractive result may be depicted in a series of “solution space” graphs, three of which are shown in FIGS. 9-12. FIGS. 9-11 assume a risk stratification approach not actually used by PHI, however, in which all participants receive the same full assessment and coaching program. This approach was used to fulfill PHI research aims, but a more reasonable risk stratification argues for differentiation of participants. So, for example, in some embodiments, only participants with a 25% or greater risk of DM and/or CHD receive the full assessment and coaching program. The implications of this stratification are discussed below, but other stratifications could be used and are contemplated herein.

FIGS. 9(a)-(c) depict economic outcomes for PHI, Emory HR, and Emory as a whole, respectively, as a function of participants' age at entrance into the program (“entering age”) and the age through which savings are accumulated (“terminal age”). Each of these figures assumes current and realistic levels of economic inflation (3%), health inflation (7%), discount rate (2%), capitated payment amount ($500), and a 50:50 split between capitation and payment for outcomes (i.e., Payment=0.5). As shown, early intervention to reduce risk provides the greatest returns as the longer time frame accrues greater cost savings. In addition, the interests of all the parties—i.e., PHI, Emory PHI, and the entire Emory organization—are well aligned because the economic outcomes track closely for all three.

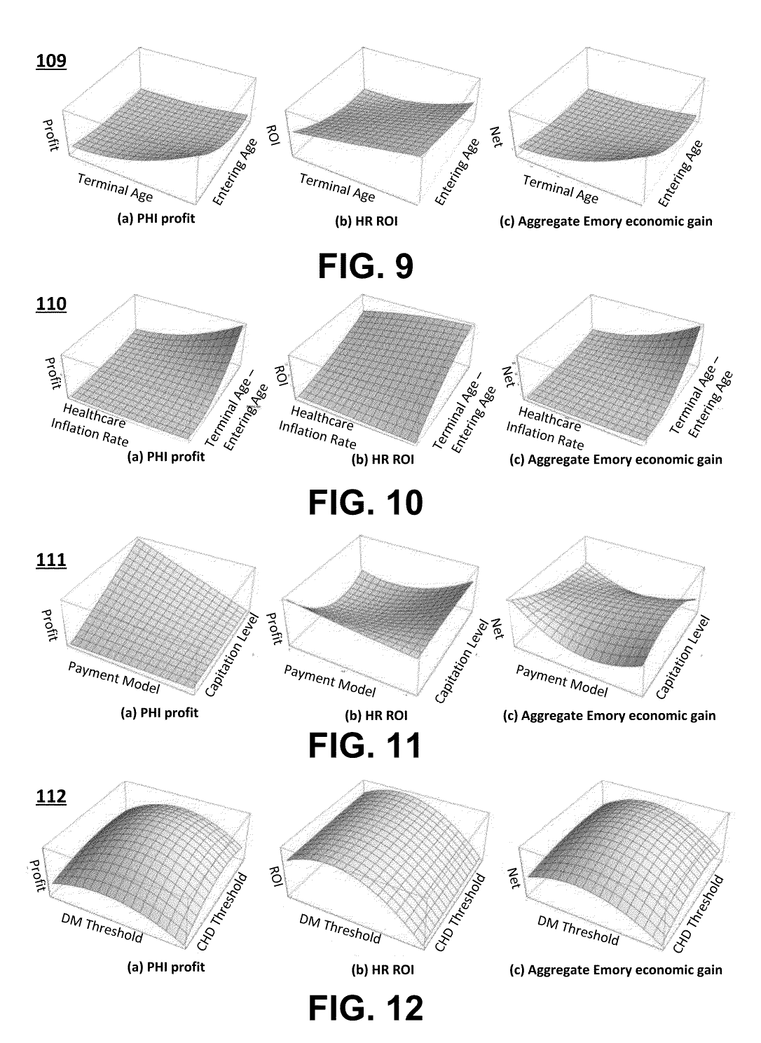

It is reasonable to expect, however, that health inflation rates will change over time. FIGS. 10(a)-(c) examine this by comparing the economic outcomes for the three parties, using the same conditions as above, but as a function of healthcare inflation and the number of years from entering to the terminal age. Similar to the first analysis, economic interests are well aligned, but in this case, because Emory HR is spending today's dollars to gain future savings, their ROI is more sensitive to the health inflation rate than to the period over which savings can be gained. In fact, PHI profit accelerates for higher levels of healthcare inflation rates and difference in entering and terminal age. ROI for Emory, on the other hand, shows a tendency to saturate. These results indicate the relative importance, sensitivity, and influence of healthcare inflation rates to both PHI and Emory HR.

As healthcare delivery moves to alternative payment models, it is important to compare the influence of pay-for-outcome and capitation levels on economic outcomes for the three participants. To this end, FIGS. 11(a)-(c) illustrate this under the same conditions as above. This analysis strikingly resembles the conflicts of interest in our current “fee for service”-based payment system. Because PHI delivers the same service to all volunteers, a pure capitated payment is essentially a fee for service. As shown in FIG. 11(a), PHI can be very profitable if the capitated payment is sufficiently large. On the other hand, PHI's profitability is reduced under a payment-for-outcomes system, in large part because its population is not prescreened for people at risk. Emory HR's results are virtually opposite, although it can still do relatively well under the right blend of capitation and pay for outcome. See, FIG. 11(b). FIG. 11(c) presents the aggregate results for Emory as a whole and, in some sense, can act as a surrogate for “society” and its overall gain under various healthcare payment systems. Here, the results are less intuitive. As shown, a typical negotiation (i.e., one that finds middle ground between the current system and the results-based system) would not result in a system that maximizes potential overall societal gain.

In other words, when the system is a compromise between the returns to HR and PHI, the aggregate returns to Emory are minimized. The best economic results are achieved when either PHI's profit is maximized or Emory HR's ROI is maximized. There are a variety of reasons why one might choose either extreme; however, there is another possibility. HR could maximize its ROI, for example, while providing PHI with a very lean budget. At the end of each year, HR could then provide PHI with a bonus for the actual savings experienced that year. This could be determined, for example, by comparing the projected costs for the people in the program to their actual costs of healthcare, absenteeism, and presenteeism. In this way, HR would be sharing actual savings rather than projected savings. The annual bonuses would eliminate PHI's fear of not being sustainable. As described below, however, PHI would need to substantially reorganize its delivery system.

It is also reasonable to expect that future healthcare delivery will need to take into account the risk characteristics of the population. FIG. 12(a)-(c) illustrate the economic trade-offs for varying the level of risk thresholds for DM and CHD. As shown, even a small increase in risk stratification (i.e., beyond no risk stratification at all) leads to a beneficial outcome for PHI and Emory as a whole. This benefit continues to increase for both diseases until a certain risk threshold level and then drops off drastically. This may happen for at least two reasons: (1) as one stratifies by risks, the system does not incur the cost of treating everyone the same way and (2) as one increases the risk thresholds, he or she has fewer eligible individuals to treat until, at some point, there are no high-risk individuals left. This result may suggest that more beneficial economic outcomes can be gained by establishing appropriately risk stratification levels.

Consider the relationships between DM and CHD. The stratification process may use disease-specific risks that are not necessarily independent variables. People who have DM, for example, have substantially increased risks of CHD. Hence, if one were to decrease resources devoted to DM risk reduction to focus resources on CHD risk reduction, the size of the population with CHD would increase because of the decrease in attention to those with high risks of DM. This is depicted in the surfaces shown in FIG. 12(a)-(c).

### 3.5 Implications of Results

In some embodiments, therefore, the financial objectives of HR and PHI—which are in conflict—should not be independently optimized. In other words, if either loses significantly, the system functions poorly. As a result, HR can adopt payment mechanisms under which PHI can redesign its delivery processes to achieve sustainability while also providing HR with an acceptable return on its investment in prevention and wellness.

For PHI to stay in business, on the other hand, it may stratify the population by risk levels and tailor processes to each stratum. This could include, for example and not limitation, an initial low-cost, streamlined assessment and subsequently PHI “lite” for low-risk participants. PHI can also develop a low-cost “maintenance” process to maintain reduced risks once they have been achieved.

### 4. Conclusions

Example embodiments of the present invention relate to a multilevel approach to organizational simulation of health delivery enterprises. This approach was illustrated using an employer-based prevention and wellness program. The multilevel computational approach to exploring alternative ways to achieve these ends may enable users to rapidly explore many alternatives, gaining insights into why many intuitively appealing ideas are, in fact, flawed, either due to unacceptable higher-order and unexpected consequences, or for other reasons.

Organizational simulation provides a powerful means to portray the vision of improved healthcare, experience it, and redesign it to better achieve the collective stakeholders' goals and objectives. As discussed above, the results may sometimes be surprising. Seemingly good ideas, for example, can have negative higher-order consequences and unintended consequences. The obvious idea of splitting the difference between current a results based systems, for example, appears to be ineffective. Fortunately, this can be discovered using the system disclosed herein, as opposed to deploying this idea in the real organization only to discover its flaws.

The examples discussed above illustrate the value of multilevel simulation as a tool to explore “what-if” scenarios in complex health delivery models. The system can be extended to, for example and not limitation, patient-centered medical homes, employer-based clinics, and outcome-based payment systems for providers. In these cases, the component models may change, but the overall approach and algorithms, for example, remain the same. The system may enable exploring “what if,” comparing it to “what is,” and tailoring the delivery system to the nature of the population served and the priorities of the participating organizations. All of this may be done in an interactive, open environment to enable participation of all stakeholders.

While several possible embodiments are disclosed above, embodiments of the present invention are not so limited. For instance, while several possible configurations of the multilevel simulation have been disclosed, other simulations could be used, for example, based on a particular business, product, or population, without departing from the spirit of embodiments of the invention. In addition, while the system is discussed above as a system for maximizing overall benefits for healthcare provision, the system could also be used, for example, for vehicle repair programs, equipment replacement programs, or other instances of general maintenance in a population (human or otherwise). In addition, the GUI, algorithms, and other features used for various features of embodiments of the present invention may be varied according to a particular population, computer system, or organization. Such changes are intended to be embraced within the scope of the invention.

### Flow Diagrams

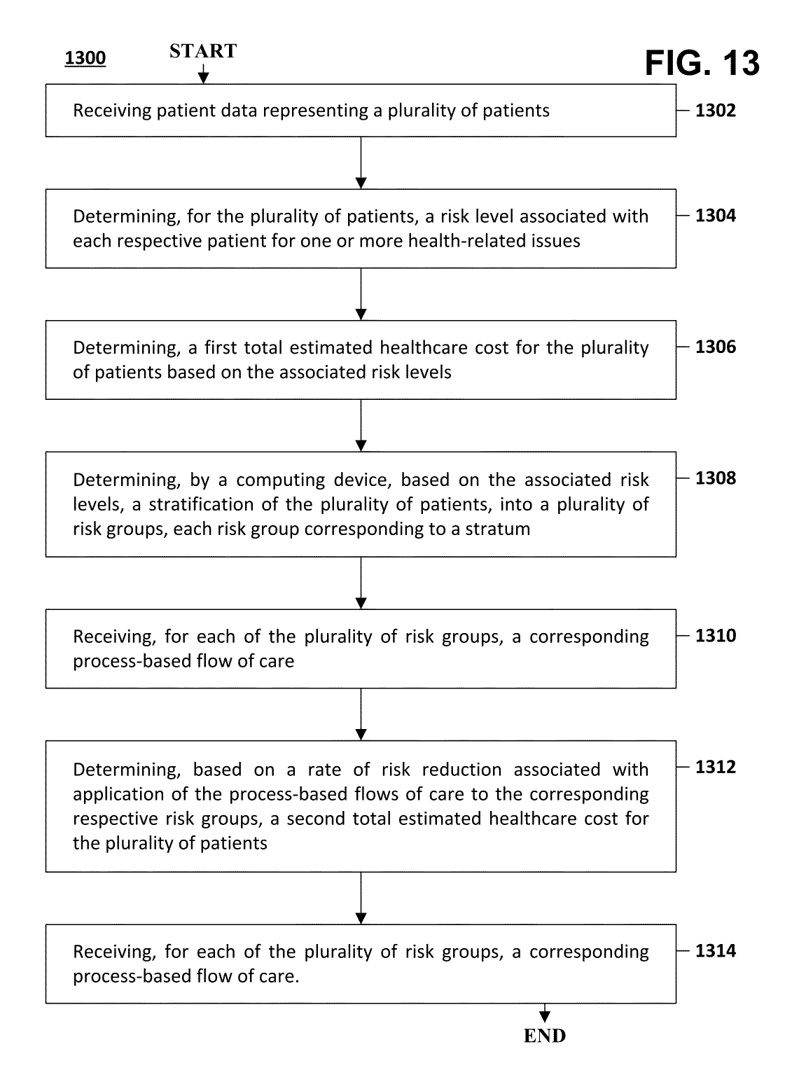

FIG. 13 depicts a flow diagram 1300 of a method, according to an embodiment of the present invention. As shown in FIG. 13, the method 1300 starts in block 1302, and, according to an example embodiment, includes receiving patient data representing a plurality of patients. In block 1304, the method 1300 includes determining, for the plurality of patients, a risk level associated with each respective patient for one or more health-related issues. In block 1306, the method 1300 includes determining, a first total estimated healthcare cost for the plurality of patients based on the associated risk levels. In block 1308, the method 1300 includes determining, by a computing device, based on the associated risk levels, a stratification of the plurality of patients, into a plurality of risk groups, each risk group corresponding to a stratum. In block 1310, the method 1300 includes receiving, for each of the plurality of risk groups, a corresponding process-based flow of care. In block 1312, the method 1300 includes determining, based on a rate of risk reduction associated with application of the process-based flows of care to the corresponding respective risk groups, a second total estimated healthcare cost for the plurality of patients. In block 1314, the method 1300 includes determining, based on the first and second total estimated healthcare costs, a cost reduction associated with the wellness and prevention program.

It will be understood that the various steps shown in FIG. 13 are illustrative only, and that steps may be removed, other steps may be used, or the order of steps may be modified.

Certain embodiments of the present invention are described above with reference to block and flow diagrams of systems, methods, or computer program products according to example embodiments of the present invention. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the present invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

While certain embodiments of the present invention have been described in connection with what is presently considered to be the most practical and various embodiments, it is to be understood that the present invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present invention, including the best mode, and also to enable any person skilled in the art to practice certain embodiments of the present invention, including making and using any devices or systems and performing any incorporated methods. The patentable scope of certain embodiments of the present invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method for simulating a processed-based wellness and prevention program comprising:
receiving patient data representing a plurality of patients;
determining, for the plurality of patients, a risk level associated with each respective patient for one or more health-related issues;
determining, a first total estimated healthcare cost for the plurality of patients based on the associated risk levels;
determining, by a computing device, based on the associated risk levels, a stratification of the plurality of patients, into a plurality of risk groups, each risk group corresponding to a stratum;
receiving, for each of the plurality of risk groups, a corresponding process-based flow of care;
determining, based on a rate of risk reduction associated with application of the process-based flows of care to the corresponding respective risk groups, a second total estimated healthcare cost for the plurality of patients; and
determining, based on the first and second total estimated healthcare costs, a cost reduction associated with the wellness and prevention program.

2. The method of claim 1, wherein receiving, for each of the plurality of risk groups, the corresponding processed-based flows of care comprises determining one or more of a sequencing, timing, allocation, and scheduling of one or more process steps associated with the process-based flow of care.

3. The method of claim 1, wherein the health-related issues are preventable or semi-preventable ailments.

4. The method of claim 1, wherein the health-related issues comprises diabetes mellitus.

5. The method of claim 1, wherein the health-related issues comprises coronary heart disease.

6. The method of claim 1, wherein the risk level associated with each respective patient is quantified at least partially based on an average time until disease onset.

7. The method of claim 6, wherein the average time until disease onset is based on a Markov process.

8. The method of claim 1, wherein the total estimated healthcare costs are based at least partially on coinsurance amount, copay amount, deductible amount, net payment amount, and third-party amount for all procedures and prescriptions to be administered to each patient in the plurality of patients.

9. The method of claim 1, wherein the wellness and prevention program is an employer-based program.

10. The method of claim 1, wherein the wellness and prevention is administered by a multi-level organization.

11. The method of claim 10, wherein a definition of the multi-level organization comprises:
an ecosystem level comprising a plurality of rules and policies related to a return on investment (ROI) for a human resources portion (HR) of a system for providing the wellness and prevention program;
an organization level comprising one or more factors related to the economic sustainability of the system;
a process level comprising a plurality of factors related to the operation of a preventative care portion (PHI) of the system; and
a people level representing the plurality of patients provided healthcare by the system,
the method further comprising determining a sustainability of the wellness and prevention program based on the cost reduction associated with the wellness and prevention program and the plurality of rules and policies.

12. A system comprising:
at least one processor;
at least one memory operatively coupled to the at least one processor and configured for storing data and instructions that, when executed by the processor, cause the system to perform a method comprising:
receiving patient data representing a plurality of patients;
determining, for the plurality of patients, a risk level associated with each respective patient for one or more health-related issues;
determining, a first total estimated healthcare cost for the plurality of patients based on the associated risk levels;
determining, by the at least one processor, based on the associated risk levels, a stratification of the plurality of patients, into a plurality of risk groups, each risk group corresponding to a stratum;
receiving, for each of the plurality of risk groups, a corresponding process-based flow of care;
determining, based on a rate of risk reduction associated with application of the process-based flows of care to the corresponding respective risk groups, a second total estimated healthcare cost for the plurality of patients; and
determining, based on the first and second total estimated healthcare costs, a cost reduction associated with the wellness and prevention program.

13. The system of claim 12, wherein receiving, for each of the plurality of risk groups, the corresponding processed-based flows of care comprises determining one or more of a sequencing, timing, allocation, and scheduling of one or more process steps associated with the process-based flow of care.

14. The system of claim 12, wherein the health-related issues are preventable or semi-preventable ailments.

15. The system of claim 12, wherein the health-related issues comprises diabetes mellitus (DM).

16. The system of claim 12, wherein the health-related issues comprises coronary heart disease (CHD).

17. The system of claim 12, wherein the risk level associated with each respective patient is quantified at least partially based on an average time until disease onset.

18. The system of claim 17, wherein the average time until disease onset is based on a Markov process.

19. The system of claim 12, wherein the total estimated healthcare costs are based at least partially on coinsurance amount, copay amount, deductible amount, net payment amount, and third-party amount for all procedures and prescriptions to be administered to each patient in the plurality of patients.

20. The system of claim 12, wherein the wellness and prevention program is an employer-based program.
